(19) United States
(12) Patent Application Publication
(10) Pub. No.: US 2026/0111564 A1
(43) Pub. Date: Apr. 23, 2026

(54) FRAMEWORK FOR LEARNING BASED RECOMMENDATION AND SCORING FOR OPERATOR ACCESS TO INFRASTRUCTURE

(71) Applicant: Oracle International Corporation, Redwood Shores, CA (US)

(72) Inventors: Joydip Kundu, Nashua, NH (US); Anindya Patthak, San Jose, CA (US)

(73) Assignee: Oracle International Corporation, Redwood Shores, CA (US)

(21) Appl. No.: 18/924,925

(22) Filed: Oct. 23, 2024

(51) Int. Cl. G06F 21/57; G06N 20/00

(52) U.S. Cl. CPC G06F 21/577; G06N 20/00; G06F 2221/034

(57) ABSTRACT

Disclosed is an improved approach to implement a learning-based recommendation system which provides a recommendation for the operator access, e.g., for the proper duration and privilege required when a new operator access request is raised for accessing the customer resource.

### BACKGROUND

In a cloud computing environment, computing systems may be provided as a service to customers. One of the main reasons for the rising popularity of cloud computing is that the cloud computing model typically allows customers to avoid or minimize both the upfront costs, as well as ongoing costs, associated with maintenance of IT infrastructures. Moreover, the cloud computing paradigm permits high levels of flexibility for the customer with regards to its usage and consumption requirements for computing resources, since the customer only pays for the resources that it actually needs rather than investing in a massive data center infrastructure that may or may not actually be efficiently utilized at any given period of time.

The cloud resources may be used for any type of purpose or applicable usage configuration by a customer. For example, the cloud provider might host a large number of virtualized processing entities on behalf of the customer in the cloud infrastructure. The cloud provider may provide devices from within its own infrastructure location that are utilized by the cloud customers. In addition, the cloud provider may provide various services (e.g., database services) to customers from the cloud. As yet another example, the cloud provider may provide the underlying hardware device to the customer (e.g., where the device is located within the customer's own data center), but handle implementation and administration of the device as part of the cloud provider's cloud environment.

One of the main functions performed by the cloud provider in the cloud computing model is the administration and maintenance of the cloud computing resources. By having the administrative staff of the cloud provider take control over these administrative tasks, this minimizes the need and costs for the customer to maintain its own IT staffing and infrastructure to handle these tasks, which is in essence one of the main advantages of the cloud computing paradigm for customers. To perform these tasks, the typical scenario is for the cloud provider's administrative staff to have full and unfettered ability to access and perform administrative functions within the cloud resources.

However, this model works poorly, or does not work at all, for regulated customers, such as banks and medical providers. The primary reason for this is that a regulated customer is, according to applicable contractual or legal requirements, supposed to be responsible for controlling the actions on every aspect of the system supporting their applications, and this responsibility is independent of the owner of the equipment or the origin of the staff performing actions on said equipment. Moreover, regulated customers often have to prove to their regulators that they are in complete control of these systems (e.g., in terms of knowing what actions were taken on the system), and that they are operating their systems in compliance with those regulations. These requirements for the regulated customers are in conflict with the conventional cloud computing scenario where the cloud provider's administrative operators—and not the cloud customer—have complete control over the cloud infrastructure resources.

A mechanism can be used to provide customer control over access to cloud infrastructure by the cloud provider's operator employees. For example, U.S. Patent Publication 2022/0353266 describes an approach to allow customer-controlled access to any cloud infrastructure, where the operator makes a specific request for the type and extent of access sought to the customer infrastructure. The customer can then decide whether to approve or deny the requested access. With this approach, the customer can manage the extent, timing, and approval process for the operator access to the cloud infrastructure resources that are associated with the cloud customer. This mechanism also audits all operator actions taken while accessing the resource and provides a comprehensive audit report to the customer.

The issue addressed by the current disclosure is that when an operator makes a request to access the customer infrastructure, it is not always clear how much access should really be requested by that operator. In general, it is almost always desirable to limit the scope of access for the operator to the minimum necessary to perform the operations and activities needed by the operator to perform the required tasks. Unfortunately, it is normally very difficult to know upfront, when a problem is developing that needs to be resolved, the exact kind or extent of access that is going to be required by the operator. If the operator does not make a request for enough access, then that operator my not end up with enough operating time or a high enough privilege level to perform the required tasks to resolve the problem. On the other hand, if the operator requests too much access, then this may create an undesirable and unnecessary amount of security exposure for the customer.

Therefore, there is a need for an improved approach to implement an operator access mechanism that addresses the issues identified above.

### SUMMARY

Embodiments of the invention provides a learning-based recommendation system which provides a recommendation for the operator access, e.g., for the proper duration and privilege required when a new operator access request is raised for accessing the customer resource.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE FIGURES

The drawings illustrate the design and utility of some embodiments of the present invention. It should be noted that the figures are not drawn to scale and that elements of similar structures or functions are represented by reference numerals throughout the figures. In order to better appreciate how to obtain the above-recited and other advantages and objects of various embodiments of the invention, a more detailed description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 provides a high-level illustration of an operator access control mechanism according to some embodiments of the invention.

FIG. 2 shows a high-level flowchart of an approach to implement some embodiments of the invention.

FIG. 3 provides an illustration of a learning-based recommendation system according to some embodiments of the invention.

FIG. 4 provides an illustration of the ticketing classifier, where a set of tickets T1-T9) are received from a ticketing system.

FIGS. 5A-B provide illustrations for the subcomponents of the activity classifier/clustering system.

FIG. 6 provides an illustration for the subcomponents of the activity classifier/clustering system to evaluate the operator activities against historical classifications for similar tickets.

FIG. 7 illustrates an activity risk profile.

FIG. 8 illustrates an activity set.

FIG. 9 provides an illustration of an activity set privilege category.

FIG. 10 illustrates an activity set.

FIG. 11 is provided to illustrate calculation of the risk profile distance between two activity sets.

FIG. 12A shows a flowchart of an approach to implement Phase 1 for activity clustering for a problem class.

FIG. 12B shows a flowchart of an approach to implement Phase 2 for cluster identification.

FIG. 12C shows a flowchart of an approach to implement Phase 3 for cluster fingerprinting.

FIG. 13 shows a flowchart of an approach to perform peer group similarity analysis for an activity set.

FIG. 14 is a block diagram of an illustrative computing system suitable for implementing an embodiment of the present invention.

FIG. 15 is a block diagram of one or more components of a system environment in which services may be offered as cloud services, in accordance with an embodiment of the present invention.

### DETAILED DESCRIPTION OF THE EMBODIMENTS OF THE INVENTION

Various embodiments are described hereinafter with reference to the figures. It should be noted that the figures are not necessarily drawn to scale. It should also be noted that the figures are only intended to facilitate the description of the embodiments, and are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiments” or “in other embodiments,” in various places throughout this specification are not necessarily referring to the same embodiment or embodiments.

Operator access control allows customers to control access by the cloud service operators to the customer cloud resources. However, as previously noted, it is not always entirely clear upfront how much access should be requested by the operator. Indeed, it is common that the duration and privilege levels requested by operators may vary drastically among operators even when the underlying problem being resolved is the same.

Embodiments of the invention provides a learning-based recommendation system which provides a recommendation for the operator access, e.g., for the proper duration and privilege required when a new operator access request is raised for accessing the customer resource.

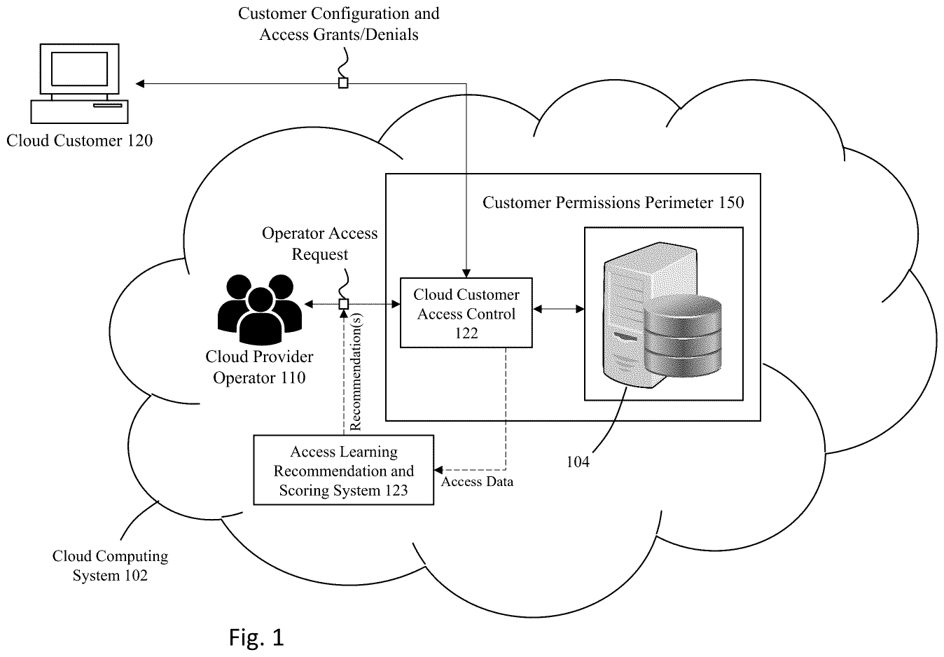

FIG. 1 provides a high-level illustration of an operator access control mechanism according to some embodiments of the invention. This figure shows a cloud computing system 102 that includes one or more cloud infrastructure resources 104 that are used by one or more cloud customers 120.

The cloud infrastructure resources 104 correspond to any type of infrastructure resource that may be allocated and used within a cloud computing environment. For example, the cloud infrastructure resources 104 may correspond to a hardware device that is shipped to a customer to use in the customer's own data center, but where the device forms part of a cloud provider's cloud environment that is maintained by the cloud provider's administrative employees. In this cloud deployment model, the customer may be responsible for the application/user-space level activities on the device, e.g., the operation and implementation of virtual machines, and/or the management of database management software that reside on machine. However, the cloud provider is responsible for management of the infrastructure components for that device (e.g., chassis power, bare metal operating system, hypervisors, storage services, networking services, etc.). In an alternative embodiment, the cloud infrastructure resource 104 is owned by the cloud provider and located within the cloud provider's own data center.

In the conventional implementations of these models, the customer has unfettered access to components they are responsible for, and the cloud provider's employee administrators have unfettered access to components that the cloud provider is responsible for. While this model works for some portions of the cloud market, this model works poorly, or does not work at all, for regulated customers, such as banks and medical providers. As previously noted, the primary reason for this problem is that a regulated customer is responsible for controlling the actions on every aspect of the system supporting their applications, and this responsibility is independent of the owner of the equipment or the origin of the staff performing actions on said equipment. Moreover, regulated customers often have to prove to their regulators that they are in complete control of these systems, and that they are operating their systems in compliance with those regulations.

A cloud customer access control mechanism 122 can be provided that allows a cloud customer 120 to implement customer control over access to the cloud infrastructure resources 104 by cloud provider operators 110. In effect, the cloud customer access control mechanism 122 creates a customer permissions perimeter 150 that allows the cloud customer to manage the extent, timing, and approval process for access to the cloud infrastructure resources 104 that are associated with the cloud customer 120.

To provide the operator access, some embodiments may implement one or more access control profiles (“ACPs”) that are created in the system. These access control profiles pertain to named and pre-defined profiles of the commands/files/network which can be accessed on a given layer. In some embodiments, these profiles are established and owned by the cloud provider. The kind of control that can be enforced by ACPs defines the technology chosen to implement the possible enforcements. The enforcement can be on any level of granularity, e.g., at the user level, file system level, kernel access level, and/or on a resources level such as, for example, for a CPU or memory. The control profiles may be used to enforce a semi-sandbox state, and may enforce what a cloud operator user can access in the system. The control profiles may also be used to enforce what the cloud operator is permitted to do in the system, e.g., pertaining to execution of shell (OS) commands, operator-developed scripts, database commands, cloud tooling commands, and/or DB client tools.

In addition, one or more customer control policies (CCCA policies) may be generated and/or configured. This is a customer-defined entity which contains a grouping of the access control profiles that are allowed and/or restricted. The policy may include a list of customer users who have permissions to approve/revoke access. In some embodiments, the CCA policy may define criteria for the users who may access the infrastructure. This could be due to, for example, legal requirements of the customer's industry and/or contractual requirements imposed upon the customer. In some embodiments, the CCA policy is created by a customer with some or all of the following attributes: (a) policy name, where the policy name should be a unique name within the tenancy; (b) identification of customer users with approval rights, which are the rights to approve access requests; (c) a policy description; (d) user attributes of the policy, which pertain to rules for the users who will request access; (e) ACPs which are automatically approved as per the policy, and in which ACPs not explicitly allowed will require approval; and/or (f) policies that are audit-only, where all ACPs are allowed automatically with only access logging enabled. One or more policies may be deployed within the system, where this is the action by which the one or more policies are associated with cloud resources within the system. Once the policy has been deployed, any operator access to the resource will be governed by the policy. The deployment can be of any length of time, e.g., made permanent or for only a specific duration.

To manage access by operators, the operators may submit an operator access request for access to a cloud resource. In some embodiments, the request includes one or more of the following: (a) the identifier of the specific resource for which access is requested; (b) the ACP that is being requested by the operator; (c) the time duration for the request; and/or (d) for auditing purposes, the reason for which the request is being made. In normal operation, the operator request can be checked against the polic(ies) that are pertinent to the request, where aa determination is made whether the automatic approval can be made for the access request. With certain embodiments of the invention, distinctions are made between different types of requests, where certain requests are deemed appropriate for automatic processing, while other requests are deemed appropriate for explicit customer approvals. For example, certain types of ACPs that pertain to read-only access of non-sensitive system information may be designated as eligible for automatic approvals (subject to logging as described in more detail below). However, other types of access to more sensitive information or activities may require explicit customer approval.

In some embodiments, upon approval for the operator access, a temporary user account is created for the operator access on the target resource. For example, in some systems, a new user (e.g., a Linux user) can be created on the target resource. The user is created to ensure clear access control and auditability for the operator user actions. As the user is created as a new temporary account, there is no existing privilege in the system. The user is deleted once the access expires and hence it is a clear removal of privilege. A chroot environment can be created for the temporary user account. A chroot on a Unix-based operating system (such as Linux) is an operation that changes the apparent root directory for the current running process and its children. The programs that run in this modified environment cannot access the files outside the designated directory tree. This essentially limits their access to a directory tree and thus they get the name “chroot jail”. This means that the cloud operator will only be able to perform its activities within the scope of the directory tree for the chroot environment that is created for the temporary user account. The operator will now be permitted to access the cloud resource using a temporary username that has been created for the operator using the operator's public key. For example, the operator may use a secure shell (SSH) to perform key-based log-in to access to the cloud resource using the temporary username that has been created for the operator. Thereafter, the operator will be permitted to perform the activities permitted by the corresponding ACP. For example, the allowed activities may include a defined set of commands executable by the operator user. These commands could be direct like issuing a “ls” on the linux machine or indirect like a shell script executed which invokes “ls”. Activities are limited to this definition and not further such as syscalls invoked or the libraries invoked by the user. It is possible that in some cases there is a delegated execution where a command is executed by the user which submits a request to a daemon running on the system. This daemon performs the command on behalf of the user. These also will be logged. At the expiry of the time duration for the operator access, the system deletes the temporary user from the target endpoint. This action may also occur upon an explicit action by the customer to revoke access. This will remove the ability of the operator to access the system.

The activities by the operator user are logged by the system. The activity monitoring is performed through audit logs generated for the activities performed by the operator, with logs being made available to the customer. One aspect of the monitoring is the ability to post the monitor logs to the customer. In some embodiments, the posted logs will include one, some or all of the following information: (a) identifier of the resource from where the logs are generated; (b) layer from which the logs are generated; (c) the user ID generating the log; (d) the access request ID which granted the access; (e) timestamp of the log. Various types of logging may be implemented, including for example, one or more of the following: (a) keystroke logging; (b) capture of all OS commands executed by operator; (c) logging of all commands executed through a script; and/or (d) logging of commands executed by a delegate (such as a daemon). The time interval may be configured as desired for the logging, e.g., with small time intervals such that the logging is in near-realtime.

As noted, the operator access control mechanism allows the customers to control access (e.g., duration and privilege level assigned to the operator). In the real world, it has been found that operators often ask for the highest level of access for a very large duration when they need access to a customer system for a problem that they are not very familiar with. This increases the risk associated with the customer system, since the system is open for access at a high privilege level for a long period of time. Secondly, customers are often not willing to grant long duration high privileged access and thus they ask operators for justification (the service allows for customer to operator interactions through a controlled chat function), and this causes delay in the operator being able to access to the system.

To address these issues, embodiments of the invention provide a learning-based recommendation system 123. The system works by performing problem classification, and also categorizing operator actions that have been taken for a given class of problem. The recommendation system works by first classifying the incident tickets behind each privileged access, and then uses a risk categorization framework to classify operator actions for each problem class. Based on the dominant cluster of operator action for a given problem class, it recommends the reasonable duration of access and the privilege level required to accomplish problem resolution. This removes guess work on the part of the operator when they ask for access.

The system can also be used to calculate a score (e.g., a “safety” score) for each operator. For example, the score can be assigned based on each access for a given problem class. The scoring can be determined based on the same risk categorization framework which can be used to see the trend of operator efficiency. The scoring can also be used as a self-feedback or to identify “experts” for a given problem class that the operator can reach out to for help.

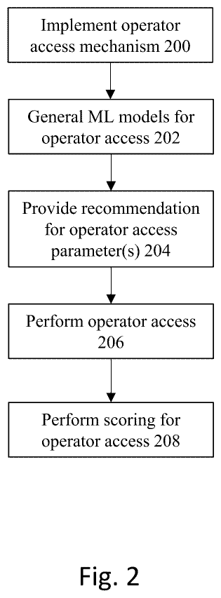

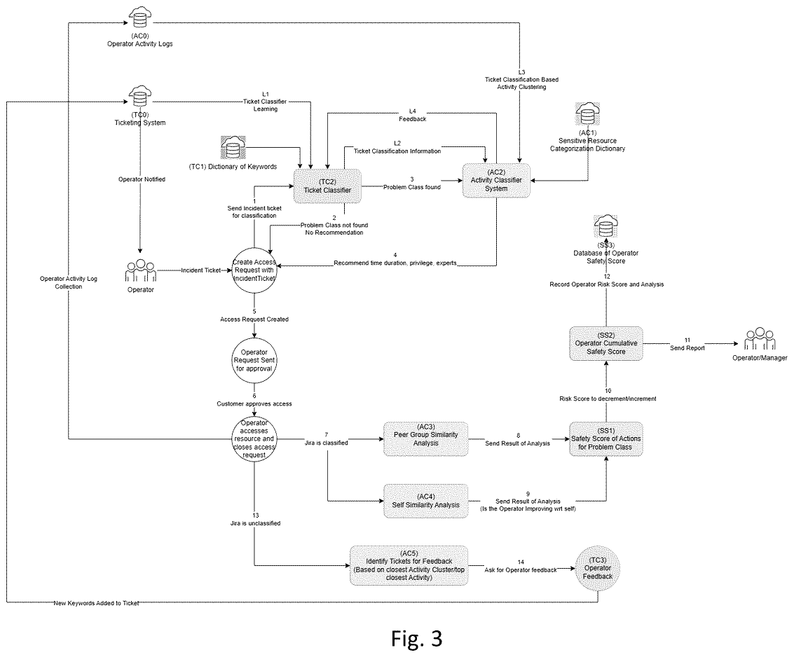

FIG. 2 shows a high-level flowchart of an approach to implement some embodiments of the invention. At 200, an operator access control mechanism is implemented, e.g., as described with respect with FIG. 1. The operator access control can be implemented as a privileged access management service that provides preventive, reactive and detective controls to the customer over infrastructure components managed by an operations team. This can be used to provide a cross-tenancy access management solution by acting as a broker between the service tenancies and customer tenancies.

From a workflow perspective, the operator access control mechanisms require the operator to declare the privilege level to be granted for access to the customer system. The following are example categories and/or types of commands that can be issued by the operator for access: (a) Read-Default: allows commands and read of files and directories with default risks; this includes commands like ps, ls, top, reading logs generated by the applications that the operator is responsible for, as well as configuration parameters set for the applications; (b) Read-Critical: allows reading reading of critical files (containing system parameters and configuration parameters that control applications); (c) Read-Sensitive: allows reading of sensitive information like /etc/passwd or Oracle wallet; (d) Write-Default: writing to temporary files or writing to files in diagnostics directory; (e) Write-Critical: writing to configuration files like sqlnet.ora, listener.ora, init.ora; (f) Write-Sensitive: writing to sensitive files like /etc/passwd, /etc/group, /etc/hosts; (g) Execute-Default: ability to start and stop default services. Ability to execute CLIs that can affect default services; (h) Execute-Critical: ability to start and stop critical services (restart database, manual backup of a PDB); along with ability to execute CLIs that can affect critical services (RMAN, SVRCTL, CRSCTL); (i) Execute-Sensitive: ability to start and stop sensitive services (like DLP, restore from backup).

The following are example of privilege levels that may be exposed by the system: (a) (P₁) Diagnostic Privilege Level: Operator can do read-only operations. Read-default, Read-Critical, Write-Default, Execute-Default; (b) (P₂) Maintenance Privilege Level: All Privileges available in P1+Write Critical+Execute-Critical; (c) (P₃) Configuration Privilege Level: Everything in P2+Read-Sensitive+Write Sensitive; (d) (P₄) Root Privilege Level: Everything in P3+Execute-Sensitive.

The reality is that there can be risks associated with the customer resources by providing access to external operators. In general, a customer system that is not under the governance of a mechanisms like the operator access control can be accessed by any operator at the system administration level (root access). For a system that is not under governance and that has not been accessed by any operator, The Ambient Risk over time-period “t”=function of (t, risk associated with root access of the system, # of operators who can access the system). It is noted that even though the function may not be explicitly defined, the system can assert certain characteristics of the function. The system can assert that the ambient risk for an ungoverned system goes up with an increase in the #of operators who have the capability to access the system as a root, as well as the period of time for which the system is accessible by the operators. For a system that over time period “t” has been accessed by “n” operator each for time tᵢ the actual risk becomes=(t−t_{A})*risk associated with potential root access to the system*# of operators who has root access to the system+Σⁿᵢ₌₁ tᵢ*Risk associated with actual root access to the system.

When no access is being provided, the ambient risk goes to 0, since no operator can access the system by default. When using operator access controls, this ambient risk stays at 0, until an access request is granted. Now say the access request for privilege level Pₓ is requested for time t_{R} with Operator actually spending t_{A} (<=t_{R}) the risk on the system, which equates to (t_{R}−t_{A})*Risk associated with potential Pᵢ level access to the system*# of operators who can access the system+Σⁿᵢ₌₁ tᵢ*Risk associated with actual Pₓ level access to the system.

There are various ways that can be used to reduce risk. For example, one approach is to bring (t_{R}−t_{A}) close to 0 (the system can never make it 0, since one cannot always absolutely predict how long the operator will need to access the system). In addition, the system can also ensure that the least privilege level needed for the access request is being requested, e.g., to ensure that Pᵢ associated with the access request is the least privileged one.

According to some embodiments, at step 202, a machine learning approach is employed to implement risk reduction for operator accesses. In particular, a learning-based recommendation system is provided to address a number of dimensions of ambient risk that a system is placed based on operator access, including (a) the duration of time the system is kept open for operator to access (regardless of the duration of access); and/or (b) the privilege level of access requested by the operator. The learning-based system performs both problem classification and categorization of operator actions.

At 204, the classifications generated by the machine learning system are used to generate recommendations for the operator access. In the learning phase, one or more dominant clusters may have been identified for the problems and the operator actions. The classifications may be correlated to aspects of duration and privilege required based on risk categorization of each action. Based on these two categorizations, the system can recommend the proper duration and privilege required when a new operator access request is raised for accessing the customer resource.

The operator may then, at step 206, perform actions pertaining to the operator access within the system. During this step, the actions of the operator will be associated certain actual datapoints or parameters associated with the access. For example, regardless of how much time was requested by the operator (Time_{requested}), the amount of time actually spent by the operator during the access may be a different amount of time (Time_{actual}). In addition, the operator will access certain resources within the system (e.g., configuration files). The details and/or parameters of the actual extent of the actions performed by the operator during the operator access are therefore logged.

At 208, the logged data is used to perform scoring for the operator access. In particular, the system computes a safety score for the operator access. This score provides feedback for: (a) feedback that identifies and compares the operator's actions compared to actions taken by other operators for the same or similar problem circumstances and/or for best practices; and/or (b) self-feedback that identifies the operator's own trend in terms of whether the operator is conforming to the operator's own best practices. The same framework is used to identify “experts” for a given problem class so novice operators can reach out for guidance.

FIG. 3 provides an illustration of a learning-based recommendation system according to some embodiments of the invention. The three main components of the system are: (a) a problem/ticket classification system; (b) activity clustering system and its interactions; and (c) a risk scoring system and its interactions. In this diagram, the white circles represent the traditional workflow for an operator.

With respect to the problem/ticket classification system, it is noted that operator access to systems is governed and audited by tickets. Every access must be to resolve an incident ticket (which may be auto generated based on some alert raised by the system, an issue reported by the customer or by some internal teams, or to collect evidence for auditing activities).

For the problem/ticket classification system, the incident ticketing database (TC1) is a database that contains all the incident tickets created for the operators. Some incidents do not require access to the system to resolve, but many do. The system uses this database to get the corpus of all incidents that required operators to access customer systems. The keyword dictionary (TC2) contains the keywords and rules used for ticket classification algorithm. The ticket classifier (TC3) is a subcomponent that periodically looks at the corpus of the TC1 and runs the classification algorithm to find new classes of tickets. It is also responsible for dynamic classification a new ticket to check if the ticket falls under an existing ticket class. The Classification Results Database (TC4) holds the results of the initial and subsequent periodic analysis. This database is consulted during dynamic classification of an incident ticket. The Operator Feedback (TC5) is the way that the system gets operators help to help the classifier to find new problem class. This allows the operator to add keywords to an existing ticket that could not be classified. Once enough tickets have been updated, a new class may be discovered by the Ticket Classifier (TC3).

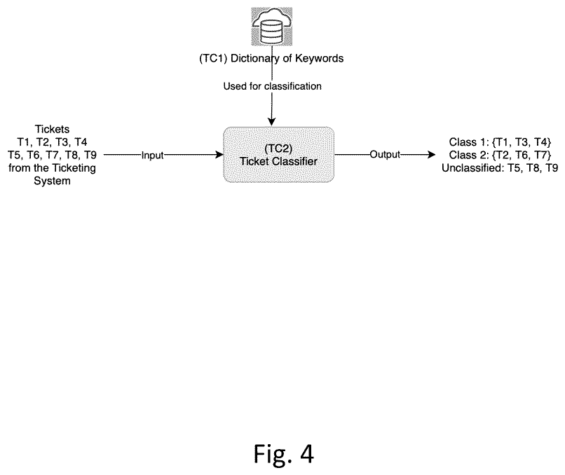

FIG. 4 provides an illustration of the ticketing classifier, where a set of tickets (T1-T9) are received from a ticketing system. Based upon the dictionary of keywords in TC1, the output comprises classes, such as Class 1 (corresponding to T1, T3, and T4), Class 2 (corresponding to T2, T6, and T7), and several tickets that may be unclassified (T5, T8, T9).

Returning back to FIG. 3, with respect to the activity classifier/clustering system, there are several subcomponents for this system. The Operator Activity Logs (AC0) is used to hold logs for activities in the system. It is noted that all actions taken by the operator are audited and the audit logs are collected by Operator Access Control system into the Operator Activity Logs (AC0). Since an operator access to a system is always associated with a ticket in the Ticketing Database, the system can always find all activity sets associated with a class of tickets in this log.

The Activity Risk Categorization Dictionary (AC1) is a dictionary of actions and resources that exist in the system and the risk categorization for each. For every action that can be performed, the system has a risk category assigned to it. Similarly for every resource there is a risk categorization. The risk categorization of an activity is the action categorization, e.g., Max (action risk, resource risk). By way of example, consider that the “ls” command is associated with an action with risk categorization of Read Default, “/tmp” is a resource with Default risk, and “/etc/passwd” is a resource with Sensitive risk. In this scenario, “ls /tmp” will be categorized as Read Default (RD), since the action categorization is Read, action risk is Default, and the resource risk is Default. “ls /etc/passwd” will be categorized as Read Sensitive (RS) since the action categorization is Read, action risk is Default, and the resource risk is Sensitive. As another example, “nmap” is an action with an action category of R, and risk category of Sensitive. Even if an “nmap” command is executed on an IP that does not point to a sensitive resource, the system can categorize use of nmap as Read Sensitive (RS)

The Activity Classifier (AC2) reads all Activity Logs for a given class of tickets, uses the Risk Categorization Dictionary rules on each set of activities, and then tries to find the set of activities that form a dense cluster. The functionality for this is described in more detail below.

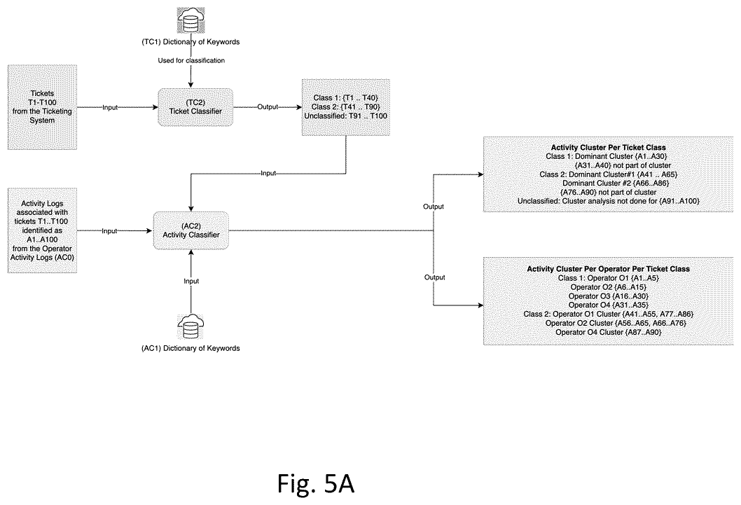

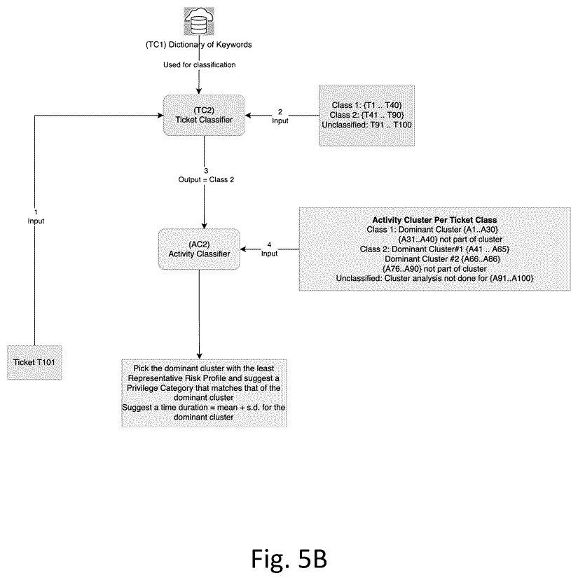

FIGS. 5A-B provide illustrations for the subcomponents of the activity classifier/clustering system. FIG. 5A illustrates the use of the activity classifier (AC2) to identify/generate activity clusters. In particular, assume that the input comprises activity logs associated with tickets T1-T100, along with activities A1-A100 from the operator activity log (AC0). Machine learning based processing may be performed upon these log entries to identify clusters. One type of output from the classification process is the identification of activity clusters on a per ticket class basis. For each pertinent class, one or more dominant clusters may be identified. In the current example, Class 1 may be associated with a dominant cluster for activities A1-A30, while Class 2 is associated with two dominant clusters, with a first dominant cluster for A41-A65 and a second dominant cluster for A66-A86. Another type of output from the classification process is the identification of activity clusters on a per operator per ticket class basis. For example, the classifier may identify Class 1 pertaining to certain activities for each of several respective operators (O1-O4), while identifying Class 2 pertaining to activities for another set of operators (O1, O2, and O4).

FIG. 5B illustrates how this system can be used to generate a recommendation. Here, the activity classifier (AC2) uses the information with regards to identification of dominant classes for certain activities. For a recommendation, a selection is made of a dominant cluster with the least representative risk profile and makes a suggestion of a privilege category that matches that of the dominant cluster. For a time duration, the recommendation corresponds to a mean plus standard deviation for the time period associated with entries in the dominant cluster.

With reference to FIG. 3, in operation of the system, the Operator may create an access request with an incident ticket (e.g., a Jira ticket). At (1), that incident ticket is sent for classification to the ticket classifier (TC2). A determination is made by the ticket classifier (TC2) whether a problem class has been identified. If a problem class is not identified, then at (2) this result is returned such that no recommendation is made at that time for the operator access. However, if a problem class is found, then at (3), the problem class is sent to the activity classifier system (AC2). The activity classifier system (AC2) will look at a history of prior acceptable operator activity, and at (4) will provide a recommendation for time duration, privilege level, and possibly identified experts for the operator access.

These steps automatically provide feedback when the operator is creating the access request based on the incident ticket referenced in the request. In particular, a check is made whether the ticket falls under a known problem category, e.g., by running a Jaccard index-based analysis. The system looks at the history of “well-behaved” operator activity associated with the problem category to identify (a) average actual duration of access with min and max; (b) min, max, average number of shared operators associated with access requests in this category; (c) the privilege associated with most access requests; (d) identification of the top-3 operators (ordered by number of well-behaved access requests issued by the operator). These are in the expert circle for this particular problem class. Expert circle for a problem class can have more than 3 members.

The system will then provide the recommendation to the operator for choosing the time duration and privilege level of access (the operator has the option to override). In addition, the system will remember the recommendation provided to the operator with the access request. Also, the system can provide the list of names who can be used for guidance with respect to the problem at hand.

At (5), the access request is then created, which is sent for approval. At (6), the customer may approve the operator access request. The operator then accesses certain resources to perform the operator actions, and when done, will close the access request.

If the incident ticket was classified, then at (7), the access information is used to perform additional analysis. At (8), peer group analysis is performed at AC3, and at (9), self-similarity analysis is performed. The analysis results are sent to SS1 for the safety scoring of the actions for the problem class. At (10), the risk score is sent to SS2 for operator cumulative scoring. At (11), a report of the scoring may be sent to the operator/manager. At (12), a record of the operator score and analysis is stored into a database (SS3).

If the incident ticket is unclassified, then at (13), the tickets are identified at (AC5) for feedback, e.g., based upon its nearest activity cluster. Thereafter, at (14), a request may be sent for operator feedback.

In essence, at the end of the request, the system may perform various levels of analysis. For a first level of analysis when the operator activities are deemed to well-behaved (falls in the dominant cluster), the system will update (e.g., increase) the safety score of the operator. In addition, a check is made to see if the operator can be placed in the expert circle for the problem class. A notification can be sent to the operator with their updated score+badge on expert circle. For a second level of analysis, if the operator activities are not deemed to be well-behaved (falls outside of the dominant cluster), an update (e.g., decrease) will be made for the safety score of the operator. A check can be made to see if the operator's activities on this problem class form its own cluster. A notification can also be made to the operator with their updated score plus how their activity differs from the pre-dominant activity cluster. The notification has a link that allows the operator to leave feedback disputing the safety score reduction. The Operator has two choices: accept the score reduction or dispute it with reasons. In either case, their cooperation score is incremented.

If the operator activities cannot be scored, then the safety score is not updated, and a report is sent to the operator with the closest matches for the problem. The operator can identify if the problem they solved match any of them. If they think there is a match, the system can ask for several keywords to describe the problem.

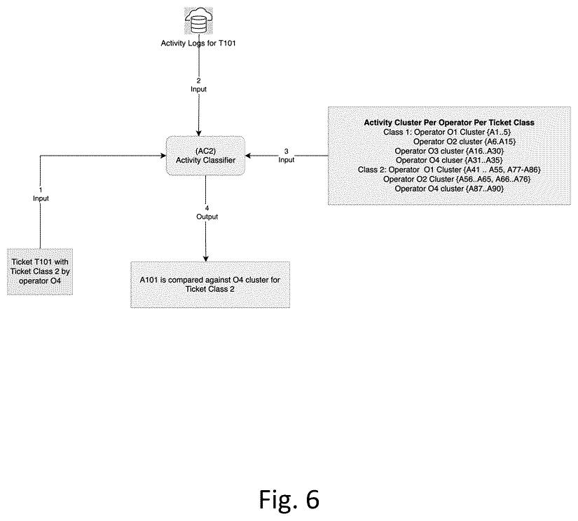

FIG. 6 provides an illustration for the subcomponents of the activity classifier/clustering system to evaluate the operator activities against historical classifications for similar tickets. In particular, this example shows a ticket T101 with a ticket class 2 by an operator O4. In this situation, the activity A101 by the operator O4 is therefore compared against the O4 cluster for ticket Class 2.

This document will now describe the learning phase for ticket classification according to some embodiments of the invention. This learning Phase is shown as the loop of L1, L2, L3, L4 in FIG. 3, which is executed initially and then maintained incrementally. This process can also be triggered periodically (e.g., on a regular basis such as once a month, or on an as-needed basis such as when the number of incident tickets created exceeds a given threshold).

With regards to ticket classification, one embodiment will operate to tokenize the text and classify based on weighting and frequency of words. This can be accomplished, for example, by following heuristics and accessing an available knowledge base. An alternative embodiment can operate performing NLP (Natural Language Processing) on incident ticket contents. In addition, an approach can be taken to have the operators help in trying to describe problems correctly. This could involve filling out a template to help classification. In one embodiment, an unsupervised learning strategy is employed based on statistical principles and expertise in the computing systems. Triggered alarms that auto create incident tickets may also include categorized information that are used to categorize the tickets.

In some embodiments, a weighted version of a Jaccard Index is employed. For each incident ticket (e.g., a ticket created in any incident management system like Jira), this approach would associate itself with a set of strings (possibly along with their frequency). The set of strings are intersection of words that appear in the incident ticket description with a global dictionary that is maintained. The dictionary is mostly static and curated based on set of incident tickets and system expert advice. Given two incident tickets, the similarity is defined as the intersection of the corresponding sets over the union of those sets. The expectation here is that similar problems will be tagged with similar set of words which we will be able to indicate a similarity score.

By way of example for the use of Jaccard similarity to classify tickets, consider the following two ticket descriptions: (a) Ticket A: “There is a problem with taking RMAN manual backup on ACD on exadata infrastructure ocid1.exadatainfrastructure.xy123456f78abc”; and (b) Ticket B: “RMAN automatic backup failing on ACD on exadata infrastructure ocid1.exadatainfrastructure.xy123456f78abc”. The following can be a dictionary of keywords for analysis: Keyword Dictionary—RMAN, backup, fail, failing, problem, ACD, infrastructure, manual, automatic.

The keywords extracted from Ticket A are ACD, BACKUP, MANUAL, PROBLEM, RMAN while from Ticket B are ACD, AUTOMATIC, BACKUP, FAILING, RMAN. The example system will also have a normalization dictionary that maps FAILING, PROBLEM to FAIL. After normalization, Ticket A can be characterized as ACD, BACKUP, FAIL, MANUAL, RMAN and Ticket B can be characterized as ACD, AUTOMATIC, BACKUP, FAIL, RMAN. In this example, the Jaccard similarity between the two tickets=(Ticket1∩Ticket2)/(Ticket1 U Ticket2)=4/6=0.67 and will be considered to be similar to each other (if one uses a similarity threshold of 0.5).

It is noted that it may be seen that the Jaccard index is defined on a set which is a un-ordered collection, effectively binary data. Here, one possible approach is to use hierarchical clustering. The exact method to be employed will depend on the nature of the data set. For example, an un-ordered approach can be used, which works better when each incident ticket can be described by a significant number of tokens. If however, incident ticket is not described well and only a few tokens can be used per incident ticket, then the system may need to employ a different classification approach. One possible alternative is to convert unordered data set into an ordered data set by help of a dictionary. Once the order is defined, the system may employ geometric algorithms, e.g. using a modified k-means approach.

In the learning phase, the system can periodically run the classifier on the corpus of incident tickets to check for new class of problems. The existing classes can be mostly stable, but a new class of problems may emerge over time. This can happen for two reasons. For example, some underlying design change may bring in a new component to the software stack and its associated problem. Initially the number of occurrences of the problem is small, and so the occurrence of the problem cannot be mapped to an existing class. However, as time passes the number of occurrences increase to a point where the new problem class emerges. Another way a new class can emerge is from operator feedback. In this case, the problem class existed, but the way the problems were described were too diverse for Jaccard index-based classifier to identify them as a class of their own. Over time, the operator feedback on problems will add enough keywords to the problem description for the classifier to detect a new problem class.

For the learning phase for activity classification, the problem class can be used to derive and perform activity cluster mapping. The activity clustering system is directed by the result of the problem classification system. All operator activity is logged in kept in a database. Once the problem classification system classifies the incidents into different classes, the activity clustering is performed based on the problem classes.

Various metrics can be defined for each activity and the activity set, where the activity set corresponds to the set of all actions performed by the operator on the protected endpoint. One approach is with regards to the risk profile for each activity, where an annotation can be made for each command seen in the activity log with its associated risks: RD, RC, RS, WD, WC, WS, ED, EC, ES, UU where R/W/E/U stand for (Read/Write/Execute/Unknown) and D/C/S/U stand for (Default/Critical/Sensitive/Unknown). The system can provide the following risk score to each risk category: RD=1, RC=2, RS=5, WD=1, WC=4, WS=9, ED=1, EC=4, ES=9, UU=4.

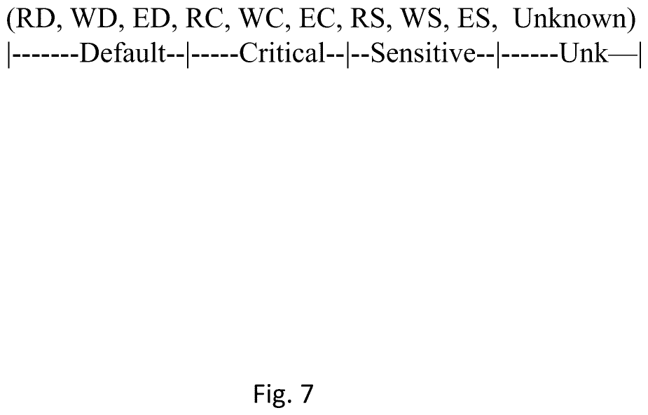

The activity risk profile can be implemented in some embodiments as a 10-tuple with only one tuple set to 1 that identifies the risk associated with the activity. Only one of the 10-tuple will have a non-zero value. The 10-tuple identifies the risk dimensions of the activity as shown in FIG. 7. In this figure, reading from left to right, Tuples 1-3 identify the default risk category, tuples 4-6 identify the critical risk category, tuples 7-9 identify the sensitive risk category, and tuple 10 identify the Unknown risk category.

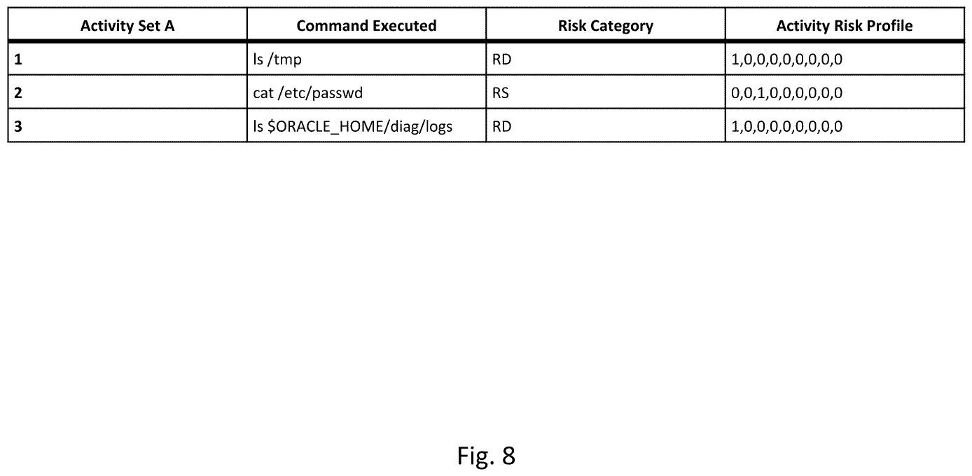

The activity set risk profile is the sum over all activity risk profiles (e.g., with non-zero counts for default risk dimensions replaced by 1) for a set of activities. By way of example, consider the activity set shown in FIG. 8. The activity set risk profile is=(1,0,0,0,0,0,0,0,0,0)+(0,0,0,0,0,0,1,0,0,0)+(1,0,0,0,0,0,0,0,0,0)=(2,0,0,0,0,0,1,0,0,0)=(after replacing 2 with 1 because of Default risk category) (1,0,0,0,0,0,1,0,0,0).

It is noted that for risk profiling, Boolean 1/0 values can be sufficiently used. However, the number of accesses would be useful to determine whether a particular command should be added to a lower privilege level. For example, if a command is needed many times, then it may make sense to allow the command at a lower privilege class than allowing root access.

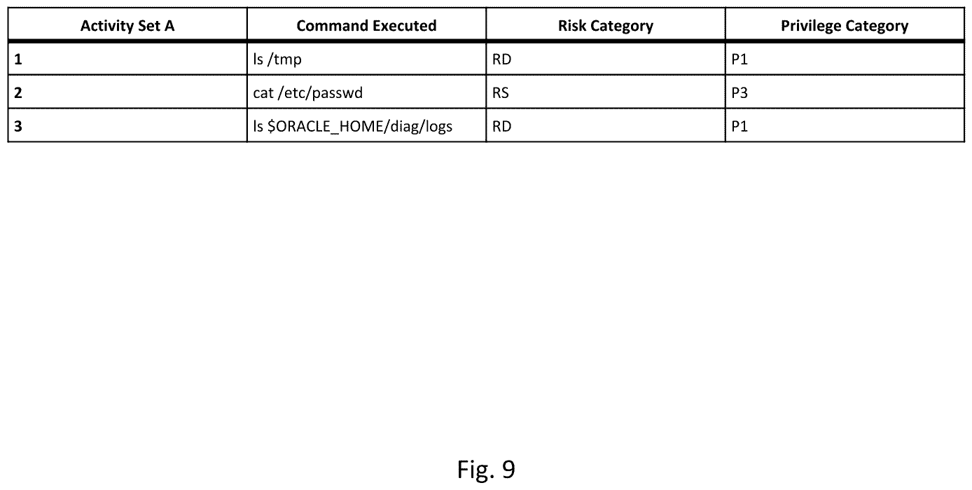

The activity set privilege category is the maximum of the min privilege required level required to perform the requested action. FIG. 9 provides an illustration of this. Here, the activity set privilege category is equal to the Max (P1, P3, P1)=P3.

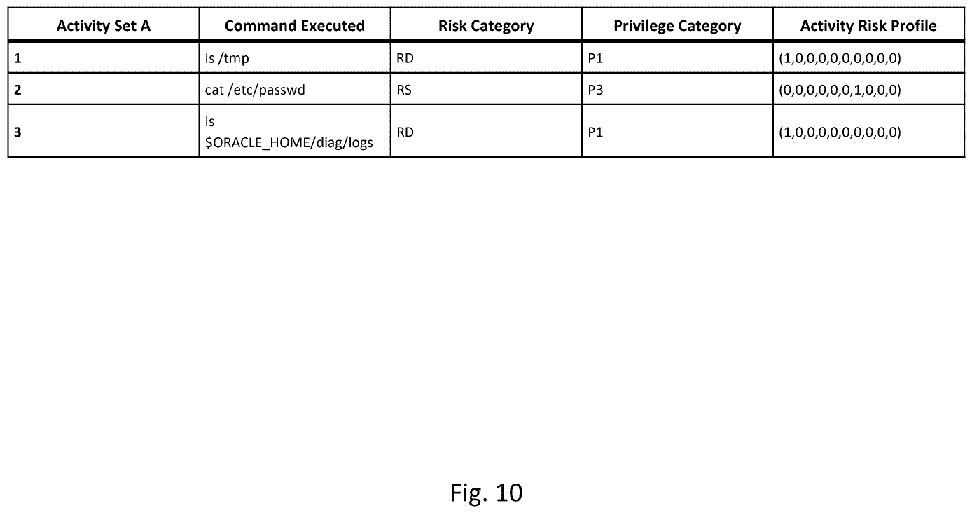

The normalized risky activity count of an activity is equal to Σ (count in i-th Risk Dimension). The activity set risk score is a coarse grained estimate of risk associated with an activity set. This is equal to Σ (count in i-th Risk Dimension)*Risk-Score of the i-th Risk Dimension. To illustrate, consider the activity set shown in FIG. 10. Here, the Activity Set Risk Profile=(1,0,0,0,0,0,1,0,0,0). The Activity Set Risk Score=1*(Risk Score of RD)+1*(Risk Score of RS)=1*1+1*5=1+5=6.

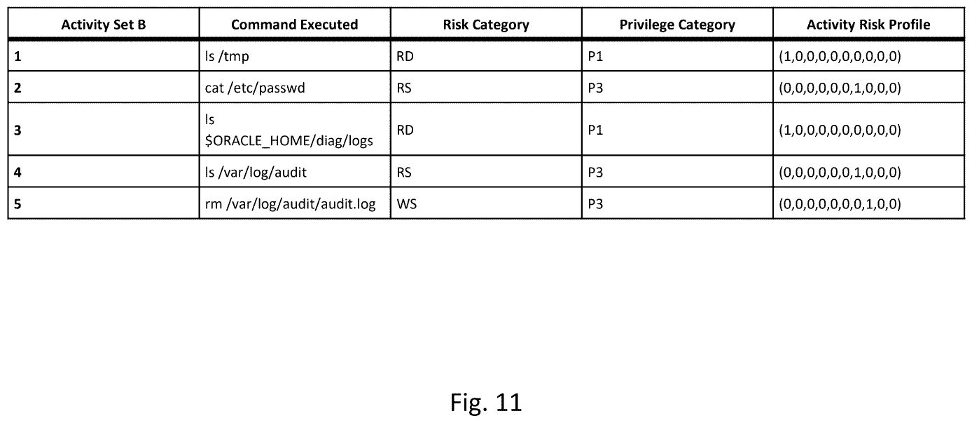

The system may also calculate the risk profile distance between two activity sets. To illustrate, consider another activity shown in FIG. 11. Here, the Activity Set Risk Profile (B)=(1,0,0,0,0,0,0,0,0,0)+(0,0,0,0,0,0,1,0,0,0)+(1,0,0,0,0,0,0,0,0,0)+(0,0,0,0,0,0,1,0,0,0)+(0,0,0,0,0,0,1,0,0,0)=(2,0,0,0,0,0,2,1,0,0)=(after replacing 2 with 1 because of Default risk category) (1,0,0,0,0,0,2,1,0,0). The Normalized Activity Count (B)=1+2+1=4.

The Risk Profile Distance Between the two Activity Sets=√Σ(over all risk dimensions) ((Distance along the risk dimension)*(risk score of the dimension))²/Average Normalized Activity Count of the Activity Sets. Here, the Risk Profile Distance (A, B)=√(((1−1)*risk score of dimension R_{D})²+((1−2)*risk score of dimension of R_{S})²+((0−1)*risk score of Wₛ)²)/(2+4)/2=(√(25+81))/3=(√(106))/3=10.29/3=3.43.

The Risk Score Distance Between Two Activity Sets can be calculated as Risk Score (B)=1*(risk score of RD)+2*(risk score of RS)+1*(risk score of WS)=1*1+2*5+1*9=20. The Risk Score Distance (A, B)=(|Risk Score(A)−Risk Score(B)|)/Average Normalized Activity Count of A and B=(|6−20|)/(2+4)/2=14/3=4.67.

It is noted that in some embodiments, both Risk Profile Distance and Risk Score Distance are calculated. One reason is because the Risk Score Distance is very easy to compute since it does not require a computation over 10-way vectors. Two activity sets that have a small Risk Score Distance may actually be very dissimilar. However, two activity sets that have a large Risk Score Distance will necessarily have a large Risk Profile Distance. One use of this is to speed up the algorithm. First, during cluster identification, one can use Risk Score of an activity set to determine which activity sets are outliers by using standard statistical analysis of computing a mean and standard deviation, and then removing activity sets that are one standard deviation away from the mean. Second, selecting the closest cluster in absence of problem classification, one can find a dominant cluster, and compute a Representative Risk Score for the cluster. Clusters are then arranged sorted on the Representative Risk Score. One can then look for the set of clusters closest based on the Raw Risk Score to do a more detailed analysis.

When determining the Representative Risk Profile for a Set of Activity Sets, this can be computed as the Representative Risk Profile(Set of Activity Sets)=(Sum of Activity Set Risk Profile)/(count of activity sets in the cluster). For example, Representative Risk Profile (A, B)=((1,0,0,0,0,0,1,0,0,0)+(1,0,0,0,0,0,2,1,0,0))/2=(2,0,0,0,0,0,3,1,0,0)/2=(1,0,0,0,0,0,1.5,0.5,0,0). In some cases, computing the representative risk profile for dissimilar activity sets is not meaningful, since the representative risk profile may only be meaningful when computed for a set of activity sets that are similar to each other.

When determining the Representative Risk Score for a Set of Activity Sets, this can be computed as the Representative Risk Score (Set of Activity Sets)=(Sum of raw risk scores for all activity sets in the cluster)/(count of activity sets in the cluster). For example, Representative Risk Score (A, B)=(6+20)/2=13.

For the process of performing activity clustering for a ticket class, a three-phase approach can be taken to implement this process for each problem class. Phase 1 perform activity clustering for a problem class. Phase 2 performs cluster identification. Phase 3 performs cluster fingerprinting.

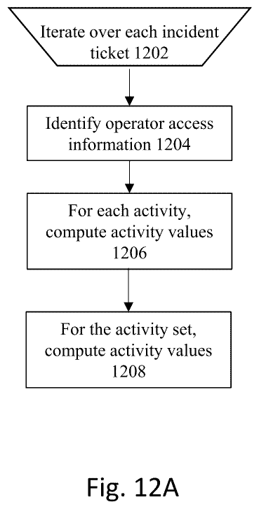

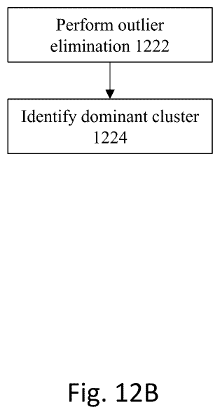

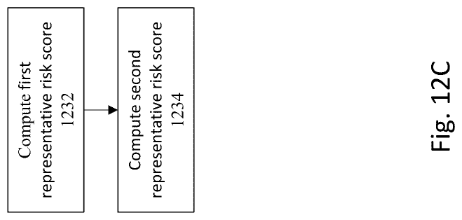

FIG. 12A shows a flowchart of an approach to implement Phase 1 for activity clustering for a problem class. Starting at step 1202, a set of processing steps is iterated over each incident ticket. At 1204, identification is made for certain operator access information. For example, information such as the privilege level and time duration requested for by the operator is identified. In addition, the processing will identify all activities performed under the ticket. Computations will be made of the number of operators, number of logins, total time spent on the system.

At 1206, this step will, for each activity, compute certain activity-related information. Example of information that are computed in this step include the Minimum Compute Privilege Category and the Activity Risk Profile for each activity.

At 1208, for the activity set, certain activity-related information will be computed. For example, this step will compute information such as the Compute Activity Set Privilege Category, Activity Set Risk Profile, and Activity Set Risk Score for the activity set.

FIG. 12B shows a flowchart of an approach to implement Phase 2 for cluster identification. At step 1222, an outlier elimination phase is performed, with respect to a cluster based on normalized raw risk score. This is essentially a coarse sieve to remove outliers at an early stage. This can be accomplished, for example, by computing Median and Standard Deviation of risk scores for the set of activity sets. This is followed by choosing all activity sets that falls under (Median+/−Standard Deviation) as the candidate dominant cluster.

Next, at step 1224, dominant cluster identification is performed. This is performed to refine the clustering based on normalized risk deviations. One possible approach that can be taken to implement this step is to employ k-means clustering based on the risk profile distance.

FIG. 12C shows a flowchart of an approach to implement Phase 3 for cluster fingerprinting. At 1232, this step computes the representative risk score for the cluster. For example, this calculation is performed over all the activity sets identified as part of the cluster. Next, at 1234, this step computes the representative risk score for the cluster. For example, this calculation is performed over all the activity sets identified as part of the cluster with two notes.

It is noted that the activity cluster for an operator can be performed in a similar fashion, by only looking at the activity history of the specific operator for a given problem class.

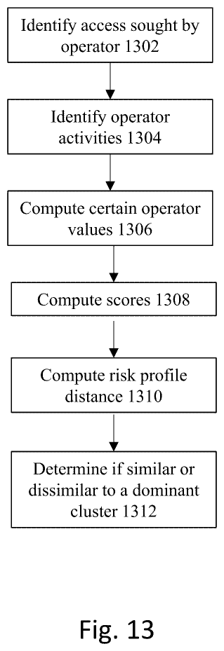

FIG. 13 shows a flowchart of an approach to perform peer group similarity analysis for an activity set. At step 1302, the process will identify the access sought by the operator. For example, this action will note the privilege level and time duration requested by the operator. At 1304, this step will identify operator activities. For example, the process will obtain all activities performed by the operator for the ticket. Next, at 1306, this step will computer certain operator data values, such as computation of number of logins and/or total time spent on the system.

At step 1308, certain scores will now be computed. For example, the system may compute the Compute Activity Set Privilege Category, the Activity Set Risk Profile, and/or the Activity Set Risk Score.

At 1310, the Risk Profile Distance is computed. This corresponds to, for example, the Representative Risk Profile for the Dominant Cluster and/or the Risk Profile for Activity Set from Operator.

At 1312, a determination is made whether the operator activity set is part of a dominant cluster. If the distance is less than a similarity threshold, then the Operator Activity Set is part of the dominant cluster. Otherwise, the Operator Activity Set is dissimilar to a dominant cluster.

With regards to the computation of a safety score, various approaches can be taken to determine this score for a given ticket class. For example, the safety score for an operator for a given category of problem ticket can start with a given value (such as for example the value 400 if the operator has no experience with fixing the ticket). For each problem ticket for which the operator stays within the dominant cluster, the safety score receives a 5 point increment. Operators with a safety score>550 is placed into a defined category (e.g., a Bronze Expert category) for the class of problem. Thus, in order for an operator to get to the Expert level for a problem category, the operator needs to solve (550−400)/5=30 tickets while staying within the dominant cluster. A score of 650 (i.e., 50 tickets while staying within dominant cluster) receives a higher level badge (e.g., a Silver Expert badge), while a score of 750 (e.g., 70 tickets while staying within the dominant cluster) earns an even higher level badge (such as a Gold Badge).

The safety score may also be decreased. For example, the safety score decrease may be implemented by: (1) Risk Profile Distance>0.2 decrease of 2 points; (2) For every 0.2 increase in Risk Profile Distance, the safety score decreases by 5 points with a max of 75 point reduction.

In some embodiments, the overall safety score for an operator can be calculated as the average of the operator's safety score over all problem classes for which they have a score.

Therefore, what has been described is an improved approach to implement a learning-based recommendation system which provides a recommendation for the operator access, e.g., for the proper duration and privilege required when a new operator access request is raised for accessing the customer resource. The disclosure provides a comprehensive system built of multiple components to guide an operator to ask for access at the right privilege level and for a reasonable duration for the class of problem being worked on by the operator. The system includes (a) a problem classification system based on keyword based Jaccard Similarity computation between two problem description; (b) a risk-oriented activity classification system that can find peer group clustering for a given problem class; this component can classify activities by computing Risk Score and Risk Profile for a set of activities, use the Risk Score and Risk Profile of Activity Sets to find dense clusters of Activity Sets, and compute Representative Risk Profile for the dense cluster; in addition, this can provide guidance to an operator raising an access request to identify the privilege category needed and a reasonable time duration needed for such a request, as well as provide guidance to an operator about the experts in their team (based on Safety Score) who can help with the problem class; a peer group similarity analysis can be provided for any given operator's activity set for a given class of problem by comparing the Risk Profile of the operator with the Representative Risk Profile of the peer group for the same class of problem, to see if operator activity conforms with the peer group in terms of risk, and a self similarity analysis provided for or any given operator's activity set for a given class of problem with their history of activities for the same class of problem to determine if the operator is improving from risk perspective; (c) a Safety Scoring system (based on the deviation of an operator's activity from their peer group), where a scoring metric is provided that indicates operational efficiency and its trend over time).

### SYSTEM ARCHITECTURE

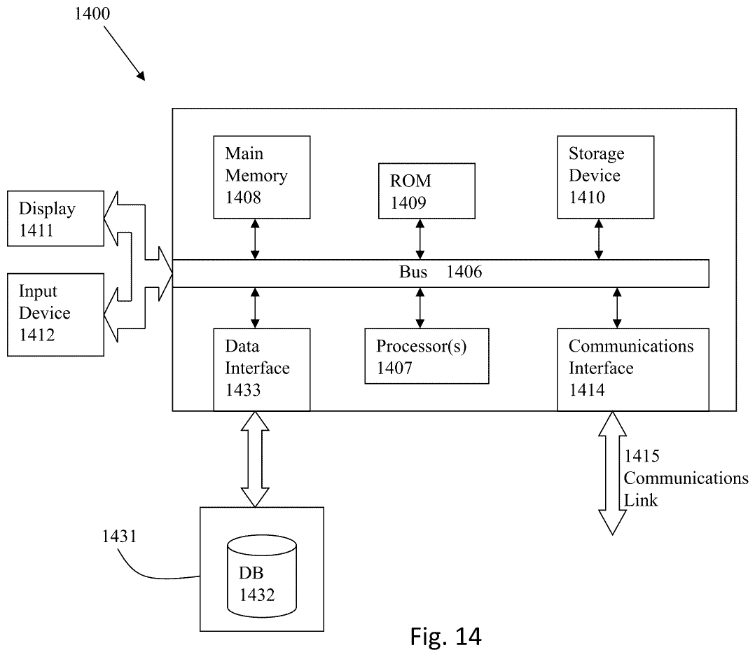

FIG. 14 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to some embodiments of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In some embodiments, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1410 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution. A database 1432 in a storage medium 1431 may be used to store data accessible by the system 1400.

The techniques described may be implemented using various processing systems, such as clustered computing systems, distributed systems, and cloud computing systems. In some embodiments, some or all of the data processing system described above may be part of a cloud computing system. Cloud computing systems may implement cloud computing services, including cloud communication, cloud storage, and cloud processing.

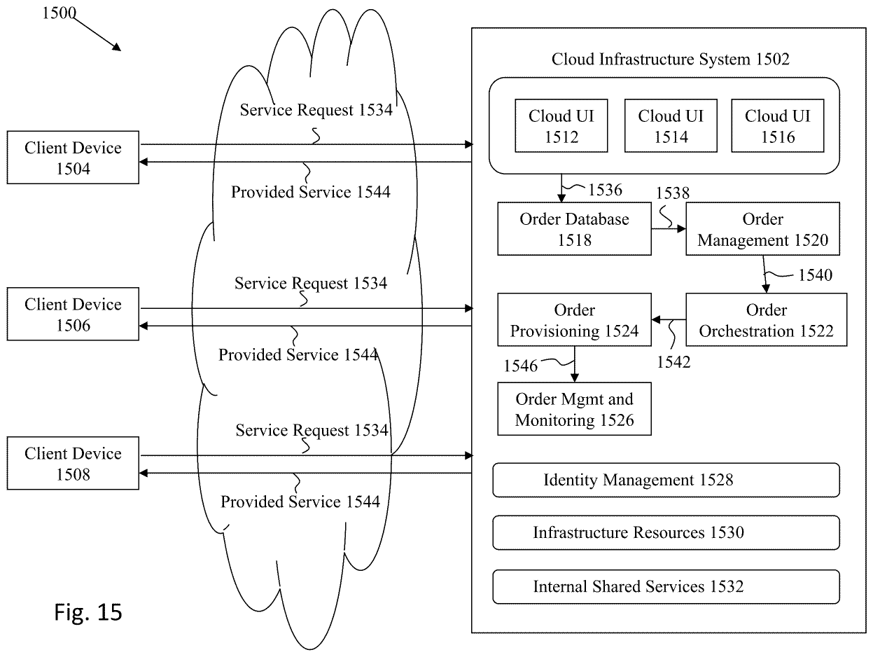

FIG. 15 is a simplified block diagram of one or more components of a system environment 1500 by which services provided by one or more components of an embodiment system may be offered as cloud services, in accordance with an embodiment of the present disclosure. In the illustrated embodiment, system environment 1500 includes one or more client computing devices 1504, 1506, and 1508 that may be used by users to interact with a cloud infrastructure system 1502 that provides cloud services. The client computing devices may be configured to operate a client application such as a web browser, a proprietary client application, or some other application, which may be used by a user of the client computing device to interact with cloud infrastructure system 1502 to use services provided by cloud infrastructure system 1502.

It should be appreciated that cloud infrastructure system 1502 depicted in the figure may have other components than those depicted. Further, the embodiment shown in the figure is only one example of a cloud infrastructure system that may incorporate an embodiment of the invention. In some other embodiments, cloud infrastructure system 1502 may have more or fewer components than shown in the figure, may combine two or more components, or may have a different configuration or arrangement of components.

Client computing devices 1504, 1506, and 1508 may be devices similar to those described above for FIG. 14. Although system environment 1500 is shown with three client computing devices, any number of client computing devices may be supported. Other devices such as devices with sensors, etc. may interact with cloud infrastructure system 1502.

Network(s) 1510 may facilitate communications and exchange of data between clients 1504, 1506, and 1508 and cloud infrastructure system 1502. Each network may be any type of network familiar to those skilled in the art that can support data communications using any of a variety of commercially-available protocols. Cloud infrastructure system 1502 may comprise one or more computers and/or servers.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 1502 may include a suite of applications, middleware, and database service offerings that are delivered to a customer in a self-service, subscription-based, elastically scalable, reliable, highly available, and secure manner.

In various embodiments, cloud infrastructure system 1502 may be adapted to automatically provision, manage and track a customer's subscription to services offered by cloud infrastructure system 1502. Cloud infrastructure system 1502 may provide the cloudservices via different deployment models. For example, services may be provided under a public cloud model in which cloud infrastructure system 1502 is owned by an organization selling cloud services and the services are made available to the general public or different industry enterprises. As another example, services may be provided under a private cloud model in which cloud infrastructure system 1502 is operated solely for a single organization and may provide services for one or more entities within the organization. The cloud services may also be provided under a community cloud model in which cloud infrastructure system 1502 and the services provided by cloud infrastructure system 1502 are shared by several organizations in a related community. The cloud services may also be provided under a hybrid cloud model, which is a combination of two or more different models.

In some embodiments, the services provided by cloud infrastructure system 1502 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 1502. Cloud infrastructure system 1502 then performs processing to provide the services in the customer's subscription order.

In some embodiments, the services provided by cloud infrastructure system 1502 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services, and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 1502 may also include infrastructure resources 1530 for providing the resources used to provide various services to customers of the cloud infrastructure system. In one embodiment, infrastructure resources 1530 may include pre-integrated and optimized combinations of hardware, such as servers, storage, and networking resources to execute the services provided by the PaaS platform and the SaaS platform.

In some embodiments, resources in cloud infrastructure system 1502 may be shared by multiple users and dynamically re-allocated per demand. Additionally, resources may be allocated to users in different time zones. For example, cloud infrastructure system 1502 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 1532 may be provided that are shared by different components or modules of cloud infrastructure system 1502 and by the services provided by cloud infrastructure system 1502. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 1502 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 1502, and the like.

In one embodiment, as depicted in the figure, cloud management functionality may be provided by one or more modules, such as an order management module 1520, an order orchestration module 1522, an order provisioning module 1524, an order management and monitoring module 1526, and an identity management module 1528. These modules may include or be provided using one or more computers and/or servers, which may be general purpose computers, specialized server computers, server farms, server clusters, or any other appropriate arrangement and/or combination.

In operation 1534, a customer using a client device, such as client device 1504, 1506 or 1508, may interact with cloud infrastructure system 1502 by requesting one or more services provided by cloud infrastructure system 1502 and placing an order for a subscription for one or more services offered by cloud infrastructure system 1502. In certain embodiments, the customer may access a cloud User Interface (UI), cloud UI 1512, cloud UI 1514 and/or cloud UI 1516 and place a subscription order via these UIs. The order information received by cloud infrastructure system 1502 in response to the customer placing an order may include information identifying the customer and one or more services offered by the cloud infrastructure system 1502 that the customer intends to subscribe to.

After an order has been placed by the customer, the order information is received via the cloud UIs, 1512, 1514 and/or 1516. At operation 1536, the order is stored in order database 1518. Order database 1518 can be one of several databases operated by cloud infrastructure system 1518 and operated in conjunction with other system elements. At operation 1538, the order information is forwarded to an order management module 1520. In some instances, order management module 1520 may be configured to perform billing and accounting functions related to the order, such as verifying the order, and upon verification, booking the order. At operation 1540, information regarding the order is communicated to an order orchestration module 1522. Order orchestration module 1522 may utilize the order information to orchestrate the provisioning of services and resources for the order placed by the customer. In some instances, order orchestration module 1522 may orchestrate the provisioning of resources to support the subscribed services using the services of order provisioning module 1524.

In certain embodiments, order orchestration module 1522 enables the management of business processes associated with each order and applies business logic to determine whether an order should proceed to provisioning. At operation 1542, upon receiving an order for a new subscription, order orchestration module 1522 sends a request to order provisioning module 1524 to allocate resources and configure those resources needed to fulfill the subscription order. Order provisioning module 1524 enables the allocation of resources for the services ordered by the customer. Order provisioning module 1524 provides a level of abstraction between the cloud services provided by cloud infrastructure system 1502 and the physical implementation layer that is used to provision the resources for providing the requested services. Order orchestration module 1522 may thus be isolated from implementation details, such as whether or not services and resources are actually provisioned on the fly or pre-provisioned and only allocated/assigned upon request.

At operation 1544, once the services and resources are provisioned, a notification of the provided service may be sent to customers on client devices 1504, 1506 and/or 1508 by order provisioning module 1524 of cloud infrastructure system 1502.

At operation 1546, the customer's subscription order may be managed and tracked by an order management and monitoring module 1526. In some instances, order management and monitoring module 1526 may be configured to collect usage statistics for the services in the subscription order, such as the amount of storage used, the amount data transferred, the number of users, and the amount of system up time and system down time.

In certain embodiments, cloud infrastructure system 1502 may include an identity management module 1528. Identity management module 1528 may be configured to provide identity services, such as access management and authorization services in cloud infrastructure system 1502. In some embodiments, identity management module 1528 may control information about customers who wish to utilize the services provided by cloud infrastructure system 1502. Such information can include information that authenticates the identities of such customers and information that describes which actions those customers are authorized to perform relative to various system resources (e.g., files, directories, applications, communication ports, memory segments, etc.) Identity management module 1528 may also include the management of descriptive information about each customer and about how and by whom that descriptive information can be accessed and modified.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A method, comprising:
implementing an operator access mechanism;
generating a machine learning model for operator access;
providing recommendations for the operator access using the machine learning model; and
performing scoring for the operator access.

2. The method of claim 1, wherein the recommendations for the operator access using the machine learning model are provided by classifying incident tickets behind a privileged access, and using risk categorization to classify operator actions for a given problem class.

3. The method of claim 1, wherein the machine learning model is used to identify a dominant cluster of operator action for a given problem class to provide the recommendations for the operator access.

4. The method of claim 1, wherein the recommendations comprising a duration of access and a privilege level.

5. The method of claim 1, wherein a score is calculated for the operator access based at least in part upon an amount of time for the operator access and identification of resources actually accessed for the operator access.

6. The method of claim 5, wherein the score is used as feedback for the machine learning model.

7. The method of claim 1, wherein the machine learning model uses a multi-phase approach for clustering comprising a first phase for activity clustering, a second phase for cluster identification, and a third phase for cluster fingerprinting.

8. A system for implementing a masked database, comprising:
a processor; and
a memory for holding programmable code, wherein the programmable code includes instructions which, when executed by the processor, cause the processor to perform a set of acts that comprises: implementing an operator access mechanism; generating a machine learning model for operator access; and providing recommendations for the operator access using the machine learning model; and performing scoring for the operator access.

9. The system of claim 8, wherein the recommendations for the operator access using the machine learning model are provided by classifying incident tickets behind a privileged access, and using risk categorization to classify operator actions for a given problem class.

10. The system of claim 8, wherein the machine learning model is used to identify a dominant cluster of operator action for a given problem class to provide the recommendations for the operator access.

11. The system of claim 8, wherein the recommendations comprising a duration of access and a privilege level.

12. The system of claim 8, wherein a score is calculated for the operator access based at least in part upon an amount of time for the operator access and identification of resources actually accessed for the operator access.

13. The system of claim 8, wherein the machine learning model uses a multi-phase approach for clustering comprising a first phase for activity clustering, a second phase for cluster identification, and a third phase for cluster fingerprinting.

14. A computer program product embodied on a non-transitory computer readable medium, the non-transitory computer readable medium having stored thereon a sequence of instructions which, when executed by a processor, causes the processor to perform a set of acts, the set of acts comprising:
implementing an operator access mechanism;
generating a machine learning model for operator access;
providing recommendations for the operator access using the machine learning model; and
performing scoring for the operator access.

15. The computer program product of claim 14, wherein the recommendations for the operator access using the machine learning model are provided by classifying incident tickets behind a privileged access, and using risk categorization to classify operator actions for a given problem class.

16. The computer program product of claim 14, wherein the machine learning model is used to identify a dominant cluster of operator action for a given problem class to provide the recommendations for the operator access.

17. The computer program product of claim 14, wherein the recommendations comprising a duration of access and a privilege level.

18. The computer program product of claim 14, wherein a score is calculated for the operator access based at least in part upon an amount of time for the operator access and identification of resources actually accessed for the operator access.

19. The computer program product of claim 18, wherein the score is used as feedback for the machine learning model.

20. The computer program product of claim 14, wherein the machine learning model uses a multi-phase approach for clustering comprising a first phase for activity clustering, a second phase for cluster identification, and a third phase for cluster fingerprinting.
